(19) United States
(12) Patent Application Publication
(10) Pub. No.: US 2006/0035075 A1
(43) Pub. Date: Feb. 16, 2006

(54) Hand-tearable adhesive masking tape for vehicles, with low shrinkback tendency

(75) Inventors: Bernhard Mussig, Seevetal (DE); Ingo Neubert, Norderstedt (DE)

Correspondence Address: Norris, McLaughlin & Marcus P.A., 18th Floor, 875 Third Avenue, New York, NY, 10022, US

(73) Assignee: tesa Aktiengesellschaft, Hamburg (DE)

(21) Appl. No.: 11/173,787

(22) Filed: Jul. 1, 2005

(30) Foreign Application Priority Data
Aug. 11, 2004 (DE) 10 2004 039 097.5

(51) Int. Cl. B32B 7/12; B32B 15/04

(52) U.S. Cl. 428/343; 428/355 R; 428/354

(57) ABSTRACT

An adhesive masking tape for the painting of vehicles and parts of vehicles, comprising a backing material and an adhesive coating applied to at least one side thereof, wherein the backing material is composed of a web of PVC material, the PVC material being composed of at least two PVC homopolymers having different K values, the K value of the polymer mixture not exceeding an average value of 63, the tensile force at 1% elongation being at least 3 N/cm, the tensile strength being 12 to 30 N/cm, the breaking elongation being in the range from 150% to 300%, the force at 10% elongation after 3 minutes being not more than 25% of the original value and the force at 50% elongation after 3 minutes being not more than 40% of the original value.

The present invention relates to a stretchable self-adhesive masking tape based on plasticized PVC backing film for masking areas prior to painting, primarily for vehicles such as, for example, automobiles or parts such as, for example, bumpers, motorbike tanks, etc. in the painting operation. The adhesive masking tape serves to produce sharp paint edges and, because of the low shrinkback tendency (high relaxation tendency) of the backing film, is particularly suitable for application to highly curved surfaces and for bonding around very narrow curves.

Self-adhesive masking tapes, including stencils formed from them, referred to below as adhesive masking tape, are required to exhibit a number of important properties in order to meet the particular demands imposed on them.

Easy stretchability when bonding in curves, in combination with a high elasticity modulus in the range of the forces encountered during unwind or during application to straight sections; little or no shrinkback tendency in the bonded state; and a low thickness are important requirements in order to be able to produce a sharp and uniform paint edge on curved surfaces and also to allow neat bonding in curves. In order to prevent shrinkage of the extended regions of the adhesive masking tape, such as come about in the outside regions in the case of bonds around narrow curves, and also during application to spherical surfaces, the backing film must reduce these tensions within a short time. This presupposes that the backing film possesses a high relaxation tendency: in other words, that the backing film possesses the property of reducing, to a large extent, internal stresses produced, for example, as a result of stretching of the backing film. There is a desire likewise on the part of the user for easy hand tearability during application, in order to achieve quick and easy usability of the adhesive masking tape: this means that it is possible to tear the adhesive masking tape without tools such as scissors or knives and also without expending great force. The term “hand tearability” encompasses tearing from the side with two hands, between thumb and index finger, and also sudden tearing in the longitudinal direction. The contradictory requirements of a high elasticity modulus and easy stretchability in conjunction with minimal shrinkage tendency and easy hand tearability can be resolved with the present invention.

To date it has been common, for this application, to use adhesive masking tapes composed of a backing film made of paper, polyester, unplasticized or plasticized PVC, polyethylene or polypropylene.

Where paper or oriented films made of polyester, unplasticized PVC, polyethylene or polypropylene are used, the stretchability, in terms of breaking elongation or the force to be expended, is too low to satisfy the requirements in the case of high deformation, such as occur, for example, in the course of thermal treatment of vehicle bumpers. Unoriented films made of soft polyolefins such as polyethylene or propylene copolymers, or plasticized PVC, do not possess hand tearability. After they have been stretched by bonding in curves, polyolefin films also exhibit shrinkback.

Adhesive tapes based on a plasticized PVC film are described, for example, in GB 2 171 712 A. Conventional plasticized PVC adhesive tapes include a fraction of more than 37 parts by weight of a monomer plasticizer based on phthalate to 100 parts by weight of PVC, composed normally of a polymer having a K value >63. The tensile strength and breaking elongation of these plasticized PVC adhesive tapes are normally too high, so that tearing of the adhesive masking tape is difficult to achieve without tools such as scissors or knives. However, the desire on the part of the user is for easy hand tearability during application.

Likewise state of the art are adhesive masking tapes which are composed of a PVC backing material in web form, composed of a PVC polymer having a K value of more than 63, usually 65 to 80, and of a mixture of monomer and polymer plasticizer with a total amount of more than 37 parts by weight per 100 parts by weight of PVC polymer. These adhesive masking tapes can likewise be torn off only with high expenditure of force. This behavior is reflected in a tensile impact strength of more than 1100 kJ/m² and breaking elongations of more than 250%. Because of their shrinkback tendency, these adhesive masking tapes are unsuitable for application to highly curved surfaces and in the case of bonds around curves with a narrow radius. The shrinkback tendency is attributable to the inadequate relaxation, of more than 35%, of the adhesive masking tape. As a result, at elevated temperatures in the operation of baking the paint, detachment of the adhesive masking tape from indentations and beads, and lifting of stretched edges in curves are observed. This leads to paint underruns and untidy paint edges.

DE 101 51 818 A1 discloses a self-adhesive masking tape for vehicles and vehicle components, comprising a backing material and, applied at least to one side thereof, an adhesive coating, the backing material being composed of a web of material that has the following properties:
an md tensile force at 1% elongation of at least 4.5 N/cm,
an md force at elongations of 10% and 150% of 12 to 28 N/cm,
an md tensile strength of 12 to 30 N/cm, and
an md breaking elongation in the range from 150% to 300%.
   (md=machine direction, i.e., longitudinal direction)

It is an object of the invention to provide a self-adhesive masking tape having a PVC-based backing material, the backing material exhibiting easy stretchability in conjunction with low shrinkback tendency and easy hand tearability. In the preferred version the stretchability is set, in nature and amount, such that not only easy deformability and curve-bondability but also low stretch during adhesive-tape application are achieved.

Unforeseeably and surprisingly for the skilled worker, an adhesive masking tape having a PVC backing on at least one side of which is applied an adhesive coating which is composed of at least two PVC homopolymers having different K values and which has the following properties
the K value of the polymer mixture does not exceed an average value of 63,
the tensile force at 1% elongation is at least 3 N/cm,
the tensile strength is 12 to 30 N/cm,
the breaking elongation is in the range from 150% to 300%,
the force at 10% elongation after 3 minutes is not more than 25% of the original value and
the force at 50% elongation after 3 minutes is not more than 40% of the original value,
   is capable of meeting the contradictory requirements for easy stretchability and low shrinkback tendency in conjunction with easy hand tearability.

The characteristic property of the backing material in the sense of the present invention is the pronounced relaxation tendency or low shrinkback tendency, which allows trouble-free application to highly spherical surfaces such as, for example, bumpers and allows bonding around narrow curves, and allows easy hand tearability, which allows the user to tear off sections of the tape without expending high force and without assistance of tools such as scissors or knives during application. As a result there is a considerable time saving in the processing operation.

As a measure of the shrinkback tendency it is possible to use the relaxation. In this case the adhesive masking tape is stretched by 10% and 50%, respectively, and then, with the stretching held constant, the residual force is determined after 3 minutes and expressed as a % age of the original force. The breaking elongation, ultimate tensile stress strength, and impact strength also serve to characterize specifically the hand tearability of the adhesive masking tape.

In order to ensure a minimum shrinkback tendency even of stretched areas during application, the adhesive masking tape must have a high relaxation tendency. Elongations of more than 50% in the outer marginal regions of the adhesive masking tape in the case of bonding around narrow curves are certainly not rare. The tensions which occur as a result must be reduced (relaxed) within a short time, in order to prevent shrinkage and, consequently, untidy or uneven paint edges.

To ensure easy hand tearability of the adhesive masking tape of the invention, the breaking elongation should be situated preferably in the range from 150% to 300%, preferably 180% to 250%, and the MD tensile strength should be in the range from 12 to 30 N/cm.

The property of hand tearability is reflected in particular in the tensile impact strength (DIN 53453, ISO/R 179); accordingly, the films should have a value preferably of less than 1000 kJ/m², more preferably less than 700 kJ/m², longitudinally with respect to the machine direction.

During stretching of the adhesive tape a force of 30 N/cm ought preferably not to be exceeded, so as to allow the adhesive masking tapes to be bonded to curves without creasing and to allow planar bonding on spherical substrates, and also to prevent detachment phenomena due to contraction forces. A breaking elongation in the range from 12 to 30 N/cm has been found advantageous. Lateral constriction (necking) in the case of the adhesive masking tape of the invention is not observed, in contrast to the polyolefin adhesive tapes. For the MD force at 1% elongation (F1% value) the aim is for a minimum value of 3 N/cm, preferably greater than 5.5 N/cm, in order to prevent stretching of the adhesive masking tape during unwind and bonding and, particularly, during automated application.

Furthermore, the drying or curing of freshly painted surfaces necessitates a thermal treatment of up to 45 minutes, which depending on the type of paint used is at temperatures from 110° C. to 160° C. In specific embodiments, the adhesive masking tape of the invention can be detached from the paint surface without residue even after a thermal load of 160° C.

Suitable PVC base materials for the films include emulsion PVC, bulk (mass) PVC, and especially suspension PVC. The relaxation behavior and the hand tearability as well are favored if the molecular weight distribution is very broad and if the average K value (DIN 53726, ISO 174) of the PVC does not exceed a value of 63. The broad molecular weight distribution and the average K value are preferably produced by mixing from at least one standard PVC (K value, for example, 65 or 70) and a specialty grade (for example, 50 or 58). In the case of the adhesive masking tape of the invention a PVC polymer blend of, preferably, 80 to 50 parts by weight of a standard PVC and 20 to 50 parts by weight of a PVC having a K value <60 are combined to give an average K value of less than 63, in order to set the specific relaxation behavior in conjunction with easy hand tearability and high elasticity modulus. Standard suspension PVC polymers having an average K value are, for example, Solvin 264PC, Solvin 271 GA (Solvin GmbH) or Vinnolit H65DS, Vinnolit S4170 (Vinnolit Kunststoff GmbH). Specialty PVC polymers having a K value <60 are, for example, Solvin 250SB (Solvin GmbH) and Vinnolit S3050 (Vinnolit Kunststoff GmbH).

In order to avoid residues on the freshly painted surfaces after the adhesive masking tape has been removed, and to prevent migration of the plasticizer into the adhesive, polymer plasticizers are preferably used. These are, for example, polyesters based on, for example, adipic, sebacic, azelaic or phthalic acid. A description of plasticizers can be found, for example, in Kunststoff-Handbuch-Polyvinylchlorid 2/1 (2nd) Hanser Verlag section 6.7.

In the present invention, plasticizers based on polyadipate esters, Palamoll 652 (BASF) or Uraplast RA 19 (DSM), for example, have proven particularly suitable. In order to optimize the properties, particularly the stress-strain behavior of the backing film of the adhesive masking tape of the invention, it is preferred to use 25 to 37 parts by weight, in particular 30 to 33 parts by weight, of one or more polymer plasticizers per 100 parts by weight of PVC polymer.

Where monomer plasticizers are used additionally, such as phthalic esters or trimellitic esters, for example, their ready migration means that it is impossible to rule out a propensity toward formation of deposits and residues; therefore, the fraction should be less than 4 parts by weight, preferably less than 1 part by weight, per 100 parts by weight of PVC polymer. At below 25 parts by weight of polymer plasticizer, the films lack stretchability and are brittle, and above 37 parts by weight of polymer plasticizer they are more difficult to tear by hand and their F1% value is too low.

The addition of stabilizers is advisable in order to prevent thermal damage to the PVC films in the course of processing and application. The function of the stabilizers consists primarily in preventing embrittlement and discoloration of the PVC backing film during the preparation and processing operation and during subsequent use. Stabilizers of this kind are described, for example, in Plastics Additives Handbook (5th Ed.) Hanser Verlag, chapter 3 and in the Kunststoff-Handbuch-Polyvinylchlorid 2/1 (2nd) Hanser Verlag section 6.3.

In particular, stabilizers based on barium/zinc compounds, calcium/zinc compounds or tin compounds are suitable for the adhesive masking tape of the invention. The use of stabilizers containing lead or cadmium, though likewise possible, ought to be avoided on toxicological and environmental grounds. The amount of stabilizer is, for example, 2 to 5 parts by weight per 100 parts by weight of PVC polymer. The use of an additional 1 to 4 parts by weight of epoxidized natural oils, epoxidized soybean oil for example, as a costabilizer, though possible, tends to be avoided owing to their migration tendency, in the same way as for the monomer plasticizers.

Further customary PVC film additives, such as fillers, pigments, impact modifiers or lubricants and processing assistants (for example, Paraloid K 120 ND, Rohm and Haas), may be used to produce the backing film of the adhesive masking tape of the invention. Examples of fillers are calcium carbonate (chalk, marble), kaolin, and silica. Their function is to set processing properties, film mechanical data, or costs. The setting of hand tearability is of little or no importance. To optimize the film's properties it is possible in addition to use PVC-compatible polymers such as, for example, chlorinated PVC, nitrile-butadiene rubber (NBR with a high AN content), polyurethane (for example, Baymod PU, Bayer), and ethylene-vinyl acetate copolymers (EVM with a high VA content, where appropriate as a terpolymer with carbon monoxide). Customary additives are described in Kunststoff-Handbuch—Polyvinylchlorid 2/1 (2nd) Hanser Verlag Chapter 6.

The adhesive masking tape of the invention may comprise, as a further additive, a crosslinked polymer, Vinnolit K 221 (Vinnolit Kunststoff GmbH) for example, or an uncrosslinked, PVC-incompatible polymer, Coathylene LD 2477 (Herberts Polymer Powders AG) or Styroflex BX 6105 (BASF) for example.

The backing film is preferably produced on a calender. Embossing of the film to adjust the unwind force is a possibility.

The PVC backing material is provided on one side with an adhesive coating. As an adhesive coating for the adhesive masking tape, suitability is possessed in particular by polyisoprene, polyisobutylene, and acrylate adhesives. Crosslinking is advantageous for improving the redetachability of the adhesive masking tape after use, and can be accomplished thermally or by exposure to UV light or electron beams. In order to ensure not only sufficient adhesion but also ease of unwind and also redetachability after use, the bond strength to steel should be situated within the range from 2.0 to 4.8 N/cm. Where appropriate, a release coating can be applied to the reverse in order to improve unwind. It is advantageous to use a primer coat between backing film and adhesive for the purpose of improving the adhesion of the adhesive to the film and hence the possibility of residue-free redetachment after use. Descriptions of the adhesives commonly used for adhesive masking tapes, and also of release coatings and primers, are found, for example, in Handbook of Pressure Sensitive Adhesive Technology, D. Satas, (3rd edition).

The adhesive masking tape of the invention, for the purpose of specialty applications, where there is a need for increased tensile strength-such as, for example, for masking window flanges during the painting operation-can likewise be laminated together, prior to application, with a further adhesive tape comprising, for example, a polyester backing material.

### Test Methods

The stress-strain characteristics of the adhesive masking tape are ascertained on type-2 test specimens (test strips 15 cm wide and 150 cm long; clamped length 100 mm) in accordance with DIN EN ISO 527-3/2/300 at a speed of 300 mm/min. The measurements are conducted under test conditions of 23±1° C. and 50±5% relative humidity.

The tensile force at 1% elongation (F1% value) is measured on a test strip 15 mm wide and 150 mm long (clamped length 100 mm) in accordance with DIN EN ISO 527-3/2/10 at a speed of 10 mm/min under test conditions of 23×1° C. and 50×5% relative humidity. The residual force in the case of elongation to 10% or 50% after 3 minutes (relaxation behavior) is determined by stretching a test strip 15 mm wide and 150 mm long (clamped length 100 mm) in a tensile-stress-measuring instrument to 110% or 150%, respectively, of its initial length and then measuring the residual force at constant elongation. The measure of the relaxation behavior is the force after 3 minutes as a percentage of the initial force value at 10% or 50% elongation. The measurements are conducted under test conditions of 23±1° C. and 50×5% relative humidity.

In order to determine the temperature stability and also residues after application, adhesive masking tapes 15 mm wide are bonded to a metal panel painted with synthetic-resin-based test paint (black paint, BASF) and are then stored at 150° C. or 160° C. for one hour. After subsequent temperature conditioning at 25° C. or 60° C., the adhesive masking tape is removed from the paint surface at these temperatures and at an angle of 180° C. This is followed by visual assessment of the residues on the paint surface, in accordance with the following criteria:
(++) no residues or ghosting at all
(+) slight ghosting
(−) ghosting or residues
(−−) severe residues or transfer of adhesive

Paint adhesion and the quality of the paint edge are tested by painting a metal panel masked in places with the adhesive masking tape. During the painting operation the paint must not fall off in beads from the surface of the adhesive tape. After the paint film has been dried and the adhesive masking tape subsequently peeled away, the adhesive tape must not tear and the paint film adhering to it must not flake, even on bending and creasing. This is followed by an assessment of the quality of the paint edge.

In order to investigate the contraction behavior of the masking tapes, test strips 20 cm long are bonded to a test substrate (painted metal panel), fastened at the ends with an adhesive tape, severed in the middle of the strip, and stored at 130° C. for 30 minutes. The gap which appears is measured and is expressed as a % of the initial length, as a measure of the contraction.

The tensile impact strength of the adhesive masking tape is determined in accordance with DIN EN ISO 8256 under test conditions of 23±1° C. and 50±5% relative humidity on samples measuring 15 mm in width and 27 mm in length. In the case of the MD tensile impact strength, the specimens are cut parallel to the machine direction and the crack extends accordingly transversely to the machine direction. The figure reported is in each case the arithmetic mean of 10 measurements. In accordance with DIN EN ISO 8256, the tensile impact strength is calculated as follows:
E=E_{c}/(x*d)*1000
E tensile impact strength
E_{c} impact energy
x sample width
d sample thickness.

The bond strengths are determined at a peel angle of 180° in accordance with AFERA 4001 on test strips 15 mm wide under test conditions of 23±1° C. and 50±5% relative humidity. The test substrates used in this case are steel plates.

Below, the invention will be illustrated with reference to a number of examples, without any intention that these should restrict the invention in any way whatsoever.

Additionally, comparative examples are given, which underline the outstanding properties of the adhesive masking tape of the invention.

### EXAMPLES

### Example 1

To produce the backing film first of all, in a high-speed mixer, a dry blend is prepared from 50 parts by weight of Solvin 258 RF (Solvin, S-PVC, K value 58), 50 parts by weight of Solvin 264 PC (Solvin, S-PVC, K value 64), 30 parts by weight of Palatinol 652 (BASF), 1.5 parts by weight of Palatinol N (BASF), 20 parts by weight of Omya EHX1 (Omya), 4 parts by weight of Baerostab UBZ 639 (Baerlocher), 2 parts by weight of Baerostab LSA (Baerlocher) and 1.5 parts by weight of Paraloid K 120 (Rohm and Haas). The dry blend is subsequently plastified in an extruder and, using a calendar, is shaped to a film having a width of 2500 mm and a thickness of 0.08 mm. The backing film is coated with a layer of adhesion promoter, consisting of a solution of 1 part by weight of natural rubber and 1 part by weight of nitrile rubber in toluene, at an application rate of 0.6 g/m², and dried. The coating of adhesive is applied directly to the adhesion promoter layer at an application rate of 25 g/m² using a comma bar. The adhesive consists of a solution of a natural rubber adhesive in petroleum spirit with a solids content of 30 percent by weight. This solution is composed of 50 parts by weight of a natural rubber, 10 parts by weight of zinc oxide, 3 parts by weight of rosin, 6 parts by weight of alkylphenol resin, 17 parts by weight of terpene-phenolic resin, 12 parts by weight of poly-β-pinene resin and 2 parts by weight of mineral oil. The coating is dried in a drying tunnel at 70° C.

The self-adhesive surface protection sheet can be unwound without visible stretching and, when used for masking automobile parts, can be applied even to difficult geometries. Uniform bonding around narrow curves is possible without creases and without lifting of the marginal regions. In elongated marginal regions a minimal contraction is observed. Tearing sections of tape off by hand requires some application of force, which is reflected in an increased figure for the tensile impact strength. Following use (painting operation) the adhesive masking tape can be removed without problems and without tearing from the bond substrate, and gives a very sharp, uniform paint edge. When relatively high paint baking temperatures are used (>140° C.), slight deposits (ghosting) are observed on the paint surface.

### Example 2

In the same way as in example 1 a backing film produced correspondingly but involving the preparation in a high-speed mixer of a dry blend from 80 parts by weight of Solvin 264 PC (Solvin, S-PVC, K value 64), 20 parts by weight of Solvin 250 SB (Solvin, S-PVC, K value 50), 31 parts by weight of Palatinol 652 (BASF), 20 parts by weight of Omya EHX1 (Omya), 4 parts by weight of Baerostab UBZ 639 (Baerlocher) and 1.5 parts by weight of Paraloid K 120 (Rohm and Haas) is coated with an adhesion promoter layer and with adhesive.

The self-adhesive surface protection sheet can be unwound without creasing and, when used for masking automobile parts, can be applied faultlessly even to difficult geometries. As a result of the lower tensile force plateau at elongations between 10% and 150%, particularly good conformability to curved surfaces, and bondability to curves, are ensured. Excellent relaxation behavior is a characteristic. As a result, the adhesive masking tape can be bonded even around very narrow curves; in the subsequent paint-baking operation there is no contraction in the elongated regions. Following use (painting operation) the adhesive masking tape can be removed without problems, instances of tearing, or residues from the bond substrate and gives a very sharp, uniform paint edge.

### Example 3

In the same way as in example 1 a backing film produced correspondingly but involving the preparation in a high-speed mixer of a dry blend from 80 parts by weight of Solvin 264 PC (Solvin, S-PVC, K value 64), 20 parts by weight of Solvin 250 SB (Solvin, S-PVC, K value 50), 4 parts by weight of Vinnolit K 221 (crosslinked PVC matting agent from Vinnolit), 31 parts by weight of Palatinol 652 (BASF), 20 parts by weight of Omya EHX1 (Omya), 4 parts by weight of Baerostab UBZ 639 (Baerlocher) and 1.5 parts by weight of Paraloid K 120 (Rohm and Haas) is coated with an adhesion promoter layer and with adhesive.

The self-adhesive surface protection sheet has a profile of properties similar to that of example 2. It is additionally distinguished by particularly easy hand tearability, without detriment to the mechanical properties to the same extent. The ease with which lateral tearing can be performed by hand is reflected in a low tensile impact strength.

### Example 4

A backing film as per example 3 is coated with an adhesion promoter layer, consisting of a solution of Desmolac (Bayer) in toluene, at an application rate of 0.6 g/m², and dried. The adhesive coating is applied directly to the adhesion promoter layer, using a comma bar, at an application rate of 25 g/m². The adhesive consists of a solution of an acrylate adhesive in toluene with a solids content of 40 percent by weight. This solution is composed of 0.3 part by weight of isocyanate and also a copolymer of 90 parts by weight n-butyl acrylate and 10 parts by weight hydroxyethyl acrylate. The coating is dried in a drying tunnel at 70° C.

The self-adhesive surface protection sheet is distinguished by properties analogous to those of example 2. However, higher paint-baking temperatures, of up to 170° C., can be used. No deposits (ghosting) or residues on the paint surface are observed.

Comparison of the properties of the inventive examples:

| | Example 1 | Example 2 | Example 3 | Example 4 |
|---|---|---|---|---|
| Thickness | 0.08 | 0.9 | 0.095 | 0.095 |
| [mm] | | | | |
| Tensile strength md* | 15 | 20 | 18 | 18 |
| [N/cm] | | | | |
| Breaking elongation md* | 178 | 235 | 218 | 218 |
| [%] | | | | |
| Force at 1% md* | 4.7 | 5.1 | 5.9 | 5.9 |
| [N/cm] | | | | |
| % forceₘₐₓ at 10% | 23 | 21 | 22 | 22 |
| after 3 min | | | | |
| % forceₘₐₓ at 50% | 34 | 32 | 33 | 33 |
| after 3 min | | | | |
| Temperature stability | + | ++ | ++ | ++ |
| at 150° C. | | | | |
| Bond strength to steel | 2.9 | 3.1 | 2.8 | 2.2 |
| [N/cm] | | | | |
| Hand tearability | + | ++ | ++ | ++ |
| Impact strength | 645/593 | 685/623 | 356/263 | 356/263 |
| md/cd* | | | | |
| [kJ/m²] | | | | |

*md = machine direction; cd = cross direction (i.e., transverse to the machine direction)

### Comparative Example 1

In the same way as for example 1 a backing film consisting of 100 parts by weight of Vinnolit H 65 D (Vinnolit, S-PVC, K value 65), 40 parts by weight of Palamoll AH (BASF), 10 parts by weight of Omya EHX1 (Omya), 4 parts by weight of Baerostab UBZ 639 (Baerlocher) and 3 parts by weight of Baerostab LSA (Baerlocher) is produced and is coated with a layer of adhesion promoter and with adhesive.

The adhesive masking tape is stretched considerably during use, with the consequence that a considerable tendency to contract at elevated temperatures is observed. The tape can be torn off in sections by hand only if a very high level of force is applied. Moreover, after use (painting operation) it cannot be removed without residue from the bond substrate. Complete transfer of the adhesive is observed.

### Comparative Example 2

In the same way as for example 1 a backing film consisting of 100 parts by weight of Solvin 265 PC (Solvin, S-PVC, K value 65), 32 parts by weight of Palamoll 652 (BASF), 20 parts by weight of Omya EHX1 (Omya), 4 parts by weight of Mark 17 M (Akcros Chem.), 2 parts by weight of Baerostab LSA (Baerlocher) and 1.5 parts by weight of Paraloid K 120 (Rohm and Haas) is produced and is coated with a layer of adhesion promoter and with adhesive.

This adhesive masking tape can be applied faultlessly in use and exhibits good bondability to curves. When the paint is baked, however, a considerable contraction is observed in the stretched regions of the adhesive masking tape, leading to paint edges that are not neat and to residues of adhesive. Processing is also made more difficult, since sections of the tape can only be torn off by hand if a heightened level of force is applied. This behavior is apparent in increased residual-force figures after elongation of 10% or 50%, in tensile impact strength, and in breaking elongation.

### Comparative Example 3

In the same way as for example 1 a backing film consisting of 100 parts by weight of Solvin 258 RF (Solvin, S-PVC, K value 58), 30 parts by weight of Palatinol 652 (BASF), 1.5 parts by weight of Palatinol N (BASF), 20 parts by weight of Omya EHX1 (Omya), 4 parts by weight of Baerostab UBZ 639 (Baerlocher), 2 parts by weight of Baerostab LSA (Baerlocher) and 1.5 parts by weight of Paraloid K 120 (Rohm and Haas) is produced and is coated with a layer of adhesion promoter and with adhesive.

This adhesive masking tape exhibits good bondability to curves in use. It does not tend to contract. Processing is made more difficult, however, since the tensile strength and breaking elongation values are low. Particularly in the case of automated application, instances of tearing are observed to an increased extent. Tearing also occurs when the adhesive masking tape is being peeled from the paint surfaces after use.

Comparison of the properties of the comparative examples:

| | Comparative | Comparative | Comparative |
|---|---|---|---|
| | example 1 | example 2 | example 3 |
| Thickness | 0.1 | 0.08 | 0.09 |
| [mm] | | | |
| Tensile strength md* | 36 | 30 | 18 |
| [N/cm] | | | |
| Breaking elongation md* | 335 | 280 | 148 |
| [%] | | | |
| Force at 1% md* | 1.3 | 3.9 | 4.1 |
| [N/cm] | | | |
| % forceₘₐₓ at 10% | 33 | 29 | 24 |
| after 3 min | | | |
| % forceₘₐₓ at 50% | 43 | 41 | 39 |
| after 3 min | | | |
| Temperature stability | −− | + | + |
| at 150° C. | transfer | | |
| Bond strength to steel | 1.1 | 2.9 | 3.0 |
| [N/cm] | | | |
| Hand tearability | −− | − | − |
| Impact strength | 2265/1930 | 1240/1159 | 864/714 |
| md/cd* | | | |
| [kJ/m²] | | | |

*md = machine direction; cd = cross direction (i.e., transverse to the machine direction)

1. An adhesive masking tape for the painting of vehicles and parts of vehicles, comprising a backing material and an adhesive coating applied to at least one side thereof, wherein the backing material is composed of a web of PVC material,
the PVC material being composed of at least two PVC homopolymers having different K values,
the K value of the polymer mixture not exceeding average value of 63,
the tensile force at 1% elongation being at least 3 N/cm,
the tensile strength being 12 to 30 N/cm,
the breaking elongation being in the range from 150% to 300%,
the force at 10% elongation after 3 minutes being not more than 25% of the original value and
the force at 50% elongation after 3 minutes being not more than 40% of the original value.

2. The adhesive masking tape as claimed in claim 1, wherein for the PVC backing material the force at an elongation by 10% after 3 minutes is not more than 20% and the force at an elongation by 50% after 3 minutes is not more than 35% of the original value.

3. The adhesive masking tape as claimed in claim 1, wherein the backing comprises 30 to 33 parts by weight of polymer plasticizer per 100 parts by weight of PVC polymer.

4. The adhesive masking tape as claimed in claim 1, wherein the backing material is composed of a PVC polymer blend of 80 to 50 parts by weight of a standard PVC and 20 to 50 parts by weight of a PVC having a K value <60, so giving an average K value of less than 63 for the PVC polymer mixture.

5. The adhesive masking tape as claimed in claim 1, wherein the tensile impact strength longitudinally with respect to the machine direction is less than 1000 kJ/m².

6. The adhesive masking tape as claimed in claim 1, wherein the PVC backing material comprises 2 to 10 parts by weight of at least one additive selected from the group consisting of crosslinked PVC polymers, PVC-incompatible polymers, and combinations thereof, per 100 parts by weight of PVC polymer.

7. The adhesive masking tape as claimed in claim 1, wherein the backing film is coated with a self-adhesive composition based on polyisoprene, polyisobutylene or polyacrylate.

8. The adhesive masking tape as claimed in at least claim 1, wherein the backing film is coated with a primer layer and pressure-sensitive adhesive layer.

9. The adhesive masking tape as claimed in claim 1, wherein said tape is removable from a substrate without residue for application up to 160° C.

10. The adhesive masking tape as claimed in claim 1, wherein the bond strength of the adhesive masking tape to a substrate is within the range of from 2.0 to 4.8 N/cm.

11. A method of masking vehicles and vehicle parts during painting, which comprises masking said vehicles and vehicle parts with the masking tape of claim 1.

12. A method for masking window flanges during the painting operation which comprises masking said window flanges with the adhesive masking tape of claim 1.

13. The adhesive masking tape as claimed in claim 5, wherein said tensile impact strength is less than 700 kJ/m².
